(19) United States
(12) Patent Application Publication
(10) Pub. No.: US 2014/0349758 A1
(43) Pub. Date: Nov. 27, 2014

(54) GAME DEVICE, COMPUTER-READABLE RECORDING MEDIUM, AND GAME MANAGEMENT METHOD

(71) Applicants: Kenji KIMURA, Minato-ku (JP); Masato AKIYAMA, Minato-ku (JP)

(72) Inventors: Kenji KIMURA, Minato-ku (JP); Masato AKIYAMA, Minato-ku (JP)

(73) Assignee: KONAMI DIGITAL ENTERTAINMENT CO., LTD., Tokyo (JP)

(21) Appl. No.: 14/458,945

(22) Filed: Aug. 13, 2014

Related U.S. Application Data
(63) Continuation of application No. PCT/JP2012/081679, filed on Dec. 6, 2012.

(30) Foreign Application Priority Data
Feb. 17, 2012 (JP) 2012-033226
Dec. 4, 2012 (JP) 2012-265580

(51) Int. Cl. A63F 13/00

(52) U.S. Cl. CPC A63F 13/00; A63F 2300/65
USPC 463/31

(57) ABSTRACT

A game device provides users with a game in which a companion relationship between the users is established. A control device executes an event in which a user and a preliminary user set including at least one constituent member participates, the at least one constituent member including a user who has not established a companion relationship with the user. The control device causes a display device of a terminal device of a user to display a preliminary user set image suggesting, to the user, the at least one constituent member included in the preliminary user set; and receives, from the user, an instruction for a companion request to one of the at least one constituent members suggested in the preliminary user set image.

### CROSS REFERENCE TO RELATED APPLICATIONS

This application is a Continuation Application of PCT Application No. PCT/JP2012/081679, filed Dec. 6, 2012, and is based on and claims the benefit of priority from prior Japanese Patent Application No. 2012-033226, filed Feb. 17, 2012, and Japanese Patent Application No. 2012-265580, filed Dec. 4, 2012, the entire contents of both of which are incorporated herein by reference.

### FIELD OF THE INVENTION

The present invention relates to a technique for providing a game in which mutualistic relationships between users (hereinafter, “companion relationships”) are established.

### BACKGROUND ART

Conventionally, there has been proposed a game that progresses while building companion relationships between users. For example, Non-Patent Literature 1 proposes a social game in which companion relationships between users are built and in which those users who are in companion relationships can cooperate with one another in an event such as fighting.

### CITATION LIST

Non-Patent Literature 1 “Social Game General Information Magazine Appli-Style Vol. 2”, published by East Press, Apr. 1, 2011, pp. 26-29.

### SUMMARY OF INVENTION

### Technical Problem

However, one of the problems in conventional games is difficulty in effectively promoting the establishment of companion relationships between users. For example, in the game described in Non-Patent Literature 1, because those who are allowed to participate in an event such as fighting, for cooperation with one another are users who have already established companion relationships, an event would not trigger the establishment of new companion relationships. In consideration of the above, the present invention has, as an object, to promote establishment of companion relationships between users in games.

### Solution to Problem

A game device of the present invention is a game device for providing users with a game in which a companion relationship between the users is established, the game device having: an event processor configured to execute an event in which a first user and a preliminary user set (preliminary user group) including at least one second user participate, the at least one second user including a user who has not established a companion relationship with the first user; a display controller configured to cause a display device to display a preliminary user set image suggesting, to the first user, the at least one second user included in the preliminary user set; and a request receiver configured to receive, from the first user, an instruction for a companion request to one of the at least one second user suggested in the preliminary user set image. The at least one second user suggested in the preliminary user set image is one or more or all of the at least one second user included in the preliminary user set of the first user.

In another aspect, a program of the present invention is a program for providing users with a game in which a companion relationship between the users is established, the program causing a computer to execute: an event process of executing an event in which a first user and a preliminary user set including at least one second user participate, the at least one second user including a user who has not established a companion relationship with the first user; a display control process of causing a display device to display a preliminary user set image suggesting, to the first user, the at least one second user included in the preliminary user set; and a request receiving process of receiving, from the first user, an instruction for a companion request to one of the at least one second user suggested in the preliminary user set image. The program of the present invention is provided in a manner stored in a computer-readable recording medium and is installed in a computer.

The present invention can be envisaged as a method for managing a game in which a companion relationship between users is established (i.e., as an operation method of the game device of the present invention). A game management method according the present invention executes an event in which a first user and a preliminary user set including at least one second user participate, the at least one second user including a user who has not established a companion relationship with the first user; causes a display device to display a preliminary user set image suggesting, to the first user, the at least one second user included in the preliminary user set; and receives, from the first user, an instruction for a companion request to one of the at least one second user suggested in the preliminary user set image.

### BRIEF DESCRIPTION OF THE DRAWINGS

FIG. 1 is a block diagram showing a game system according to a first embodiment of the present invention.

FIG. 2 is a schematic diagram of user information.

FIG. 3 is a schematic diagram of a game screen.

FIG. 4 is a flowchart of a coworking event processing.

FIG. 5 is a schematic diagram of a game screen.

FIG. 6 is a schematic diagram of a game screen.

FIG. 7 is a schematic diagram of a candidate-for-request image.

FIG. 8 is a schematic diagram of an individual page of each user.

FIG. 9 is a flowchart of a companion request processing.

FIG. 10 is a flowchart of an interaction processing.

FIG. 11 is a schematic diagram of a history image in a second embodiment.

FIG. 12 is a schematic diagram of a preliminary user set image in a third embodiment.

### DESCRIPTION OF EMBODIMENTS

### First Embodiment

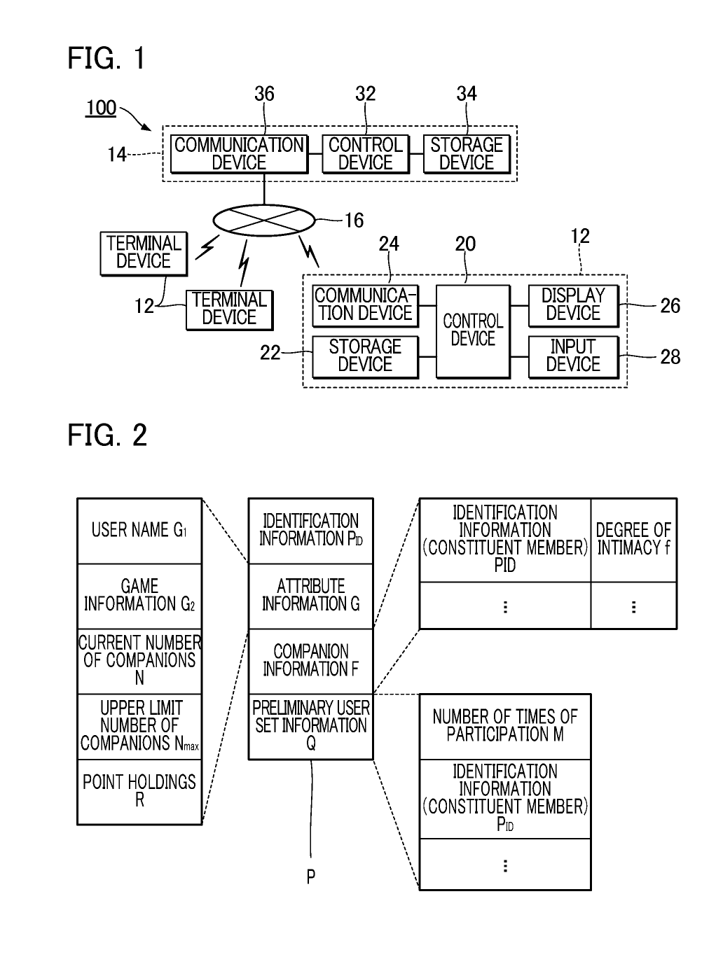

FIG. 1 is a block diagram of a game system 100 according to a first embodiment of the present invention. The game system 100 of the first embodiment has plural terminal devices 12 and a game device 14. Each of the terminal devices 12 and the game device 14 communicate with each other via a communication network 16 (e.g., mobile communication network or the Internet).

Each terminal device 12 is a communication terminal such as a portable telephone device and a portable information terminal (PDA: Personal Digital Assistant). Each terminal device has a control device 20, a storage device 22, a communication device 24, a display device 26, and an input device 28. The control device 20 is a computer processing device that controls each element of the terminal device 12 in an integrated manner. The storage device 22 stores computer programs executed by the control device 20 and various data used by the control device 20. The communication device 24 communicates with the game device 14 via the communication network 16. Communication between the terminal device 12 and the communication network 16 is typically wireless communication. However, in a configuration such as one in which a stationary personal computer, etc., is used as the terminal device 12, the terminal device 12 and the communication network 16 may communicate by wire.

The display device 26 (e.g., a liquid crystal display panel) displays various types of images under control of the control device 20. The input device 28 is an instrument for a player to input an instruction for the terminal device 12, and includes, for example, plural operators operated by a player. A touch panel that is integrally configured with the display device 26, a microphone for vocally inputting an instruction to the terminal device 12, or both of the touch panel and the microphone may be employed as the input device 28.

The game device 14 is a server device (typically, a web server) for providing a game for a user of each terminal device 12. In FIG. 1, the game device 14 is illustrated as a single block for simplicity. However, the game device 14 may be configured with plural devices (server devices) separately installed at different locations from one another. For example, the game device 14 may be configured with a system having an SNS (Social Networking Service) server and a game server exclusively used for providing games, so that the SNS server performs one or more of the functions of the game device 14 of the first embodiment.

A game provided by the game device 14 of the first embodiment is a social game in which various types of events are caused to progress while building companion relationships among users, and it is provided for each terminal device 12 typically as a browser-type (web-type) application. A user of each terminal device 12 can participate in an event (e.g., fighting against an opponent character) in the game in cooperation with another user (companion) who is in the companion relationship with the user of the terminal device 12 and can exchange messages or items with the companion. Thus, building companion relationships with many users allows each user to control the game advantageously. The companion relationship between users is established when a companion request from a user is approved by the other user.

As shown in FIG. 1, the game device 14 of the first embodiment has a control device 32, a storage device 34, and a communication device 36. The communication device 36 communicates with each terminal device 12 via the communication network 16. The storage device 34 stores computer programs executed by the control device 32 and various types of data used by the control device 32. A publicly-known recording medium, such as a semiconductor recording medium or a magnetic recording medium, or a combination of plural types of recording mediums, can be employed as the storage device 34. A configuration can be employed in which the storage device 34 is provided at a separate external device (e.g., a server) that is a separate unit from the game device 14, so that the game device 14 receives information from the storage device 34 via the communication network 16. Thus, the storage device 34 is not an essential requirement for the game device 14. Also, the storage device 34 may be configured with plural pieces of storage circuitry independent from one another.

The storage device 34 of the first embodiment stores, for respective users, user information P (FIG. 2) relating to a user. As illustrated in FIG. 2, the user information P is configured to include identification information P_{ID}, the attribute information G, the companion information F, and the preliminary user set information Q. Each element of the user information P may be stored in separate pieces of storage circuitry in such a state in which the elements are correlated with one another. In the following description, from among plural users who play games at the terminal devices 12, a freely selected user (hereinafter referred to as “user U_{A}”) is focused on for the sake of simplicity.

The identification information P_{ID} is a sign based on which the user U_{A} is uniquely identifiable. The attribute information G is data specifying the situations of the user U_{A} in the game. As shown in FIG. 2, the attribute information G includes a user name G₁, game information G₂, the current number of companions N, the upper limit number of companions Nₘₐₓ, and point holdings R. The user name G₁ is a denomination of the user U_{A} (or a character symbolizing the user U_{A}) in the game. The game information G₂ is information showing progress situations of the game for the user U_{A}, and specifies an ability value (e.g., level, physical strength, attack power, defense power, etc.,) of the user U_{A} or items, etc., obtained by the user U_{A} in the game.

The current number of companions N is the total number of other users who have established companion relationships with the user U_{A}. In contrast, the upper limit number of companions Nₘₐₓ means the maximum value of the total number of users with whom the user U_{A} can build companion relationships. That is, the user U_{A} is allowed to build companion relationships with other users until the current number of companions N reaches the upper limit number of companions Nₘₐₓ. The upper limit number of companions Nₘₐₓ is set variable along with the progress of the game depending on, for example, the level, etc., of the user U_{A}. The point holdings R in FIG. 2 are the quantities of points (virtual currency) the user U_{A} can use in the game. The user U_{A} can obtain, for example, an item, for example, in exchange for consumption of predetermined quantity of the point holdings R.

The companion information F is, as shown in FIG. 2, specifies the identification information P_{ID} and the degree of intimacy f about respective users who are in companion relationships with regard to the user U_{A}. The total number of the identification information P_{ID} specified by the companion information F is equivalent to the current number of companions N. The companion relationship in the first embodiment means a mutualistic relationship between users. Therefore, the companion information F of one of the users who is in the companion relationship specifies the identification information P_{ID} of the other user. The degree of intimacy f is an index value representing the degree of friendship between users who are in the companion relationship. For example, interaction between users such as exchange of messages or items, etc., causes the degree of intimacy f to increase. The higher the degree of intimacy f between users, the more advantageously each user can control the game. For example, at times of interaction between users, the number of points depending on the degree of intimacy f is added to the point holdings R of each user (described later in detail).

In the game of the first embodiment, a set of plural users (hereinafter referred to as “preliminary user set”) who participate in a specific event (hereinafter referred to as “coworking event”) with the user U_{A} is defined separately from the companion relationship between users. After deepening friendship in advance by progressing a coworking event with a user (hereinafter referred to as “constituent members U_{B}”) constituting the preliminary user set for the user U_{A}, the user U_{A} can build companion relationships with each constituent member U_{B}. Thus, the preliminary user set for the user U_{A} is equivalent to a preliminary group for building a companion relationship with respect to the user U_{A}.

The preliminary user set information Q of FIG. 2 is information relating to the preliminary user set for the user U_{A} and specifies the identification information P_{ID} of respective constituent members U_{B} of the preliminary user set for the user U_{A} and the number of times M the preliminary user set for the user U_{A} has participated in an event with the user U_{A}. In the following, the relationship between the user U_{A} and each constituent member U_{B} of the preliminary user set for the user U_{A} will be referred to as “coworking relationship” for simplicity. In the first embodiment, a case is assumed in which the user U_{A} and the preliminary user set for the user U_{A} participate in a coworking event of fighting against an opponent character, to cooperate with each other. It is to be noted that the above-mentioned companion relationship is a mutualistic relationship between users, but that the coworking relationship in the first embodiment is a one-way relationship between users. Specifically, for the constituent members U_{B} of the preliminary user set for the user U_{A}, the user U_{A} is not necessarily a constituent member of the preliminary user set for the constituent member U_{B}.

The control device 32 of FIG. 1 provides a game for each terminal device 12 by execution of a computer program stored in the storage device 34. Specifically, the control device 32 receives, from terminal device 12, an instruction from a user made to the input device 28 of the terminal device 12 to execute a process according to the instruction, and transmits image data of an image (webpage) indicating a result of the process from the communication device 36 to the terminal device 12, thereby causing the display device 26 of the terminal device 12 to display a screen of the game. It is to be noted that, since the game of the first embodiment is a browser game that progresses by the game device 14 by responding to a request from the terminal device 12, responses to respective terminal devices 12 take place asynchronously with one another. Thus, the game of the first embodiment is an asynchronous type game in which plural players do not have to play simultaneously. The control device 32 may be configured with plural processing circuitry independent from one another.

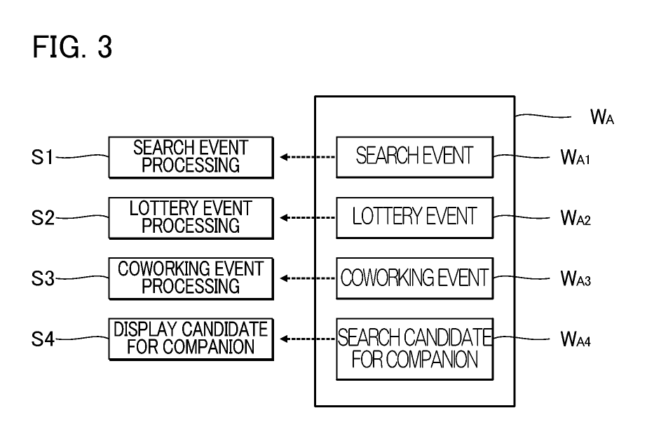

When the user U_{A} instructs the start of the game by an operation to the input device 28, the control device 32 causes the display device 26 of the terminal device 12 of the user U_{A} to display a game screen W_{A} in FIG. 3. There are arranged plural operation images W_{A1} to W_{A4} in the game screen W_{A}. Each of the operation images W_{A1} to W_{A4} is an image (a link object such as a link text or a command button) for which a link to another page has been set can be selected by the user U_{A} freely with an operation to the input device 28.

When the user U_{A} selects the operation image W_{A1} (search event) with an operation to the input device 28, the control device 32 causes a search event in which the user U_{A} participates alone to progress (S1). Specifically, the control device 32 updates the game information G₂ (e.g., the ability value or item holdings of the user U_{A}) of the user U_{A} according to a result of a game process including a lottery processing, etc., and causes the display device 26 of the terminal device 12 to display a display effective image expressing a search in a virtual space (e.g., cave), etc.

When the user U_{A} selects the operation image W_{A2} (lottery event) of the game screen W_{A} in FIG. 3, the control device 32 grants an item to the user U_{A} in exchange for consumption of a predetermined quantity of the point holdings R of the user U_{A} (S2). Specifically, the control device 32 deducts the predetermined quantity from the point holdings R of the user U_{A}, selects an item by a predetermined lottery process, and grants the item to the user U_{A}. Thus, the user U_{A} can advantageously progress the game by increasing the point holdings R and therefore by frequently executing lottery events.

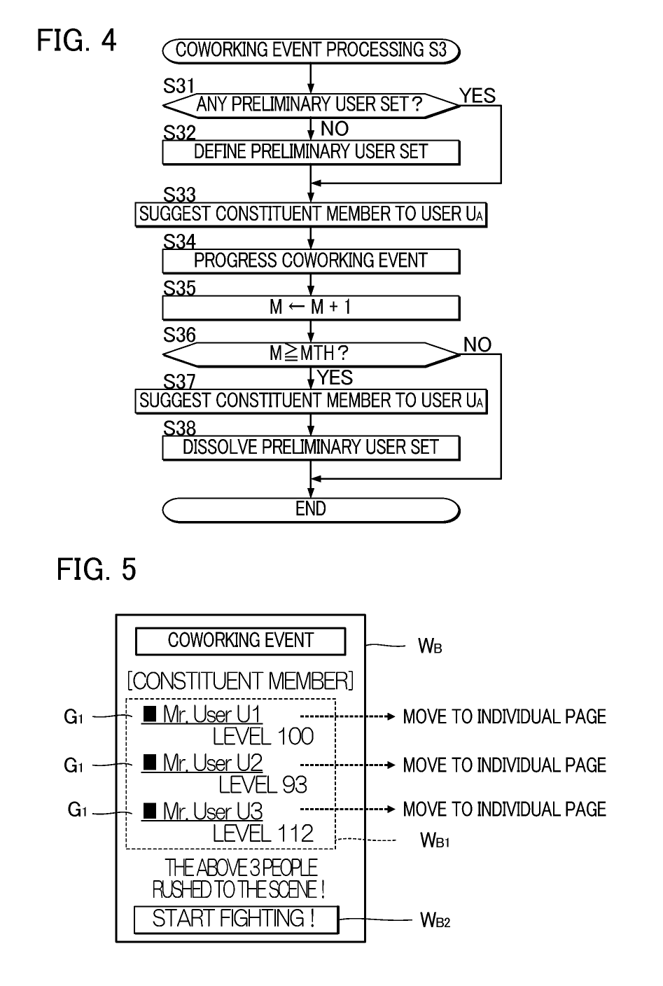

When the user U_{A} selects the operation image W_{A3} (coworking event) in the game screen W_{A} in FIG. 3, the control device 32 executes a coworking event processing S3 of FIG. 4 for causing the coworking event in which the user U_{A} and the preliminary user set for the user U_{A} participate to progress. Upon starting the coworking event processing S3, the control device 32 determines whether a preliminary user set for the user U_{A} has presently been defined (S31). In a case in which the preliminary user set for the user U_{A} has not been formed (a case in which the coworking event processing S3 is executed for the first time or the existing preliminary user set has been dissolved in Step S38 (described later)), the control device 32 defines a preliminary user set for the user U_{A} (S32). Specifically, the control device 32 selects K constituent members U_{B} from plural users other than the user U_{A}, and adds the preliminary user set information Q to the user information P of the user U_{A}, the preliminary user set information Q specifying pieces of the identification information P_{ID} of respective constituent members U_{B} and the number of times of participation M (M=0) in the coworking event by the preliminary user set. Description will be given in the following of a method of selecting K constituent members U_{B}.

The preliminary user set defined with respect to the user U_{A} can include constituent members U_{B} who are in the companion relationships with the user U_{A} (hereinafter referred to as “companion constituent members U_{B1}”) and constituent members U_{B} who are not in the companion relationships with the user U_{A} (hereinafter referred to as “non-companion constituent members U_{B2}”). The control device 32, from among the K constituent members U_{B} constituting the preliminary user set for the user U_{A}, sets the number of members K₁ of the companion constituent members U_{B1} and the number of members K₂ of the non-companion constituent members U_{B2} (proportion of K₁ and K₂) so as to vary depending on the current number of companions N and on the upper limit number of companions Nₘₐₓ of the user U_{A}. Specifically, the K constituent members U_{B} are selected so as to satisfy each of the following conditions in view of promoting the establishment of companion relationships between the user U_{A} and the non-companion constituent members U_{B2} within the range of the upper limit number of companions Nₘₐₓ of the user U_{A}.

First, when the current number of companions N of the user U_{A} has not reached the upper limit number of companions Nₘₐₓ (when there is capacity to increase the number of companions), the control device 32 selects the K constituent members U_{B} so as to include at least one non-companion constituent member U_{B2}. On the other hand, when the current number of companions N of the user U_{A} has reached the upper limit number of companions Nₘₐₓ (when there is no capacity to increase the number of companions), the control device 32 selects the K constituent members U_{B} so that every member of the K constituent members U_{B} will be the companion constituent member U_{B1} (first condition). Second, the control device 32 selects the K constituent members U_{B} so that the fewer the current number of companions N of the user U_{A}, the more the number of members K₂ of the non-companion constituent members U_{B2} will increase (so that the number of members K₁ of the companion constituent members U_{B1} will decrease) (the second condition).

For example, a case in assumed in which the preliminary user set is configured of three constituent members U_{B} (K=3) and in which the upper limit number of companions Nₘₐₓ of the user U_{A} is 10. If the current number of companions N is 10 (N=Nₘₐₓ), three out of 10 users who are in the companion relationships with the user U_{A} are selected as the constituent members U_{B} (companion constituent members U_{B1}). If the current number of companions N is 0, three users who are not in companion relationships with the user U_{A} are selected as the constituent members U_{B} (non-companion constituent members U_{B2}). When the current number of companions N is equal to or greater than one and equal to or fewer than five, one companion constituent member U_{B1} and two non-companion constituent members U_{B2} are selected. When the current number of companions N is equal to or greater than six and equal to or fewer than nine, two companion constituent members U_{B1} and one non-companion constituent member U_{B2} are selected.

In a case in which the total number of users satisfying both the first condition and the second condition exceeds K, K users satisfying a predetermined condition are selected as the constituent members U_{B}. For example, a configuration of selecting K users who are close in level to the user U_{A}, a configuration of selecting K users in ascending order of the number of times they joined the preliminary user sets of other users, or a configuration of selecting K users who are close in the latest log-in time to the user U_{A} may be preferably employed. As is understood from the foregoing description, the control device 32 executes the process of Step S32, whereby an element (user set definer) of selecting, from among multiple users, at least one user (constituent member U_{B}) included in the preliminary user set for the user U_{A} is actualized. As described previously, the preliminary user set for the user U_{A} may include the constituent member U_{B} (non-companion constituent member U_{B2}) who has not yet established a companion relationship with the user U_{A}.

When the preliminary user set for the user U_{A} is newly defined according to the procedure above (S32), or when the preliminary user set for the user U_{A} has already been defined (S31: YES), the control device 32 causes the game screen W_{B} of FIG. 5 to be displayed on the display device 26 of the terminal device 12 of the user U_{A} (S33). As shown in FIG. 5, the game screen W_{B} includes a preliminary user set image W_{B1} and an operation image W_{B2}. The preliminary user set image W_{B1} is a list suggesting respective constituent members U_{B} of the preliminary user set for the user U_{A} to the user U_{A}. Specifically, a user name G₁ and a level (game information G₂) specified by the attribute information G are displayed for each of the constituent members U_{B}. The display of each user name G₁ for respective constituent members U_{B} is an image (link object) for which a link has been set to a unique page for the constituent member U_{B} (hereinafter referred to as “individual page”).

The operation image W_{B2} (Start Fighting!) of FIG. 5 is an image for receiving an instruction for starting a coworking event from the user U_{A}. When the operation image W_{B2} is operated, the control device 32 causes a coworking event in which the user U_{A} and the preliminary user set for the user U_{A} participate to progress (S34). For example, the control device 32 compares the total value of the ability value (game information G₂) of the user U_{A} and the ability values of respective constituent members U_{B} of the preliminary user set with the ability value of an opponent character, to determine victory or defeat, and causes the display device 26 of the terminal device 12 of the user U_{A} to display a result of the process (victory or defeat). Thus, the control device 32 executes the process of Step S34, whereby an element (event processor) of executing an event in which the user U_{A} and the preliminary user set for the user U_{A} participate is actualized.

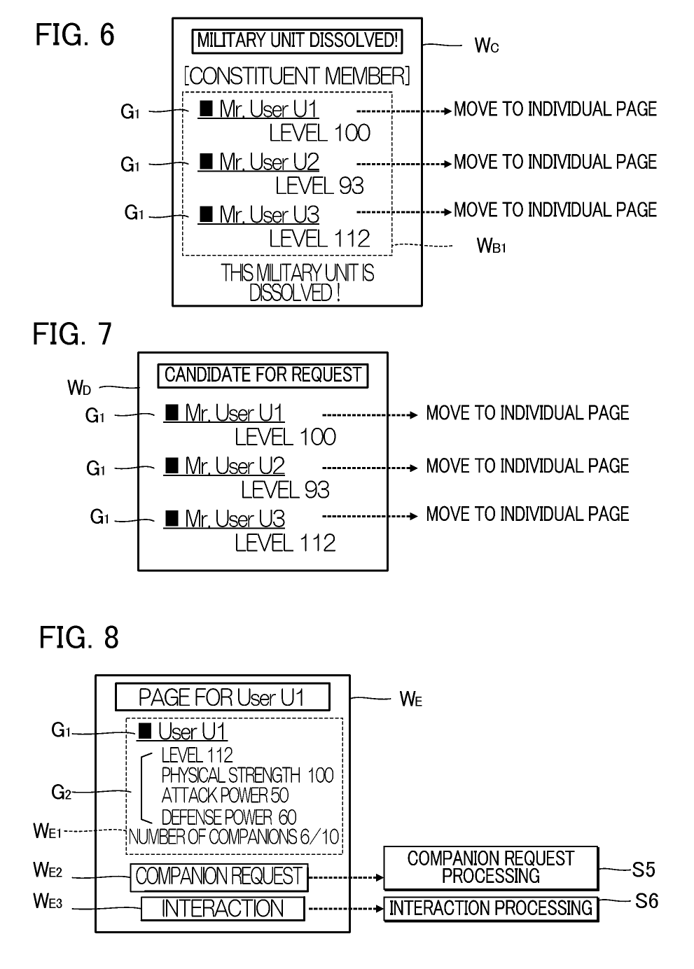

When the coworking event ends (S34), the control device 32 adds 1 to the number of times of participation (the number of times the preliminary user set has participated in the coworking event) M, the number of times of participation M being specified by the preliminary user set information Q of the user U_{A} (S35), and determines whether the number of times of participation M after the addition is equal to or greater than a predetermined value M_{TH} (S36). The predetermined value M_{TH} is, for example, set to a numerical value of 2 or greater. When the number of times of participation M is equal to or greater than the predetermined value M_{TH} (S36: YES), the control device 32 causes the display device 26 of the terminal device 12 of the user U_{A} to display the game screen W_{C} of FIG. 6, suggesting, to the user U_{A}, the breaking up (dissolution) of the preliminary user set for the user U_{A} currently being set (S37).

The game screen W_{C}, in the same way as the game screen W_{B}, includes the preliminary user set image W_{B1} suggesting respective constituent members U_{B} of the preliminary user set. The display of each user name G₁ for respective constituent members U_{B} is linked to the individual page of each constituent member U_{B}. The control device 32 causes the preliminary user set for the user U_{A} to be broken up (dissolved) (S38). For example, the control device 32 deletes the preliminary user set information Q of the user U_{A} from the storage device 34. On the other hand, when the number of times of participation M has not reached the predetermined value M_{TH} (S36: NO), Steps S37 and S38 are not executed. Accordingly, the preliminary user set for the user U_{A} is not dissolved but is maintained also in the subsequent coworking event.

As is understood from the foregoing description, the control device 32 executes the process of Step S33 or Step S37, whereby an element (display controller) causing the display device 26 of the terminal device 12 of the user U_{A} to display the preliminary user set image W_{B1} suggesting, to the user U_{A}, respective constituent members U_{B} of the preliminary user set for the user U_{A} is actualized. Also, the control device 32 executes the processes of Step S36 and Step S38, whereby an element (user set dissolver) of dissolving the preliminary user set after a plural number of times (M_{TH} number of times) of execution of coworking events in which the preliminary user set for the user U_{A} participate is actualized. The definition (establishment) and dissolution of the preliminary user set for the user U_{A} is sequentially repeated. The preliminary user set information Q of the first embodiment only specifies one preliminary user set (the latest preliminary user set) which is currently effective.

When the user U_{A} selects the operation image W_{A4} (searches for a candidate companion) in the game screen W_{A} of FIG. 3, the control device 32 causes the display device 26 of the terminal device 12 of the user U_{A} to display a candidate-for-request image W_{D} of FIG. 7 suggesting candidates for companion requests to the user U_{A} (S4). The candidates for the companion request are selected in a free manner, for example, from among users who are not established companion relationships or coworking relationships with the user U_{A}. Displayed in the candidate-for-request image W_{D} are, for each candidate for a companion request by the user U_{A}, the user name G₁ and a level (game information G₂) specified by the attribute information G. The display of each user name G₁ for respective candidates is linked to an individual page of each candidate.

When the user U_{A} selects the user name G₁ of a desired user (hereinafter referred to as “target user U_{C}”) from among the constituent members U_{B} suggested in the preliminary user set image W_{B1} in the game screen W_{B} of FIG. 5 or in the game screen W_{C} of FIG. 6 and from among candidates suggested in the candidate-for-request image W_{D} of FIG. 7, the control device 32 causes the display device 26 of the terminal device 12 of the user U_{A} to display an individual page W_{E} of the target user U_{C}. FIG. 8 is a schematic diagram of the individual page W_{E} of the target user U_{C} (the user name G₁: User U₁). As illustrated in FIG. 8, arranged in the individual page W_{E} are a user area W_{E1} in which pieces of information on the target user U_{C} are arranged, an operation image W_{E2}, and an operation image W_{E3}. Arranged in the user area W_{E1} are, for example, the user name G₁ of the target user U_{C}, respective ability values specified by the game information G₂ of the target user U_{C}, and the current number of companions N and the upper limit number of companions Nₘₐₓ (N/Nₘₐₓ) of the target user U_{C}. On the other hand, each of the operation image W_{E2} (companion request) and the operation image W_{E3} (interaction) is an image (a link object for which a link to another page has been set) for receiving an instruction from the user U_{A}. Specifically, the user U_{A} operates the operation image W_{E2}, thereby instructing a companion request for the target user U_{C}, and operates the operation image W_{E3}, thereby instructing an interaction with the target user U_{C}.

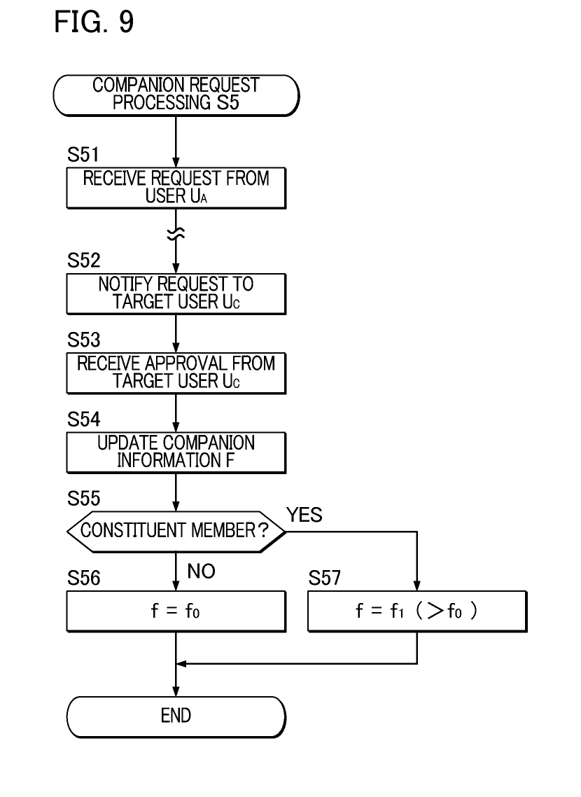

When the user U_{A} operates the operation image W_{E2} (companion request) of FIG. 8, the control device 32 executes the companion request processing S5 of FIG. 9. Upon starting the companion request processing S5, the control device 32 receives an instruction for a companion request (an operation of the operation image W_{E2}) for the target user U_{C} from the terminal device 12 of the user U_{A} (S51). The control device 32 notifies the terminal device 12 of the target user U_{C} of the companion request from the user U_{A}, with an operation (e.g., log-in) performed by the target user U_{C} to the terminal device 12 as a trigger (S52). As is understood from the foregoing description, the control device 32 executes the process of Step S51, whereby an element (request receiver) of receiving from the user U_{A} an instruction for a companion request to the constituent member U_{B} suggested in the preliminary user set image W_{B1} (or a candidate suggested in the candidate-for-request image W_{D}) is actualized.

The target user U_{C} is allowed to instruct the terminal device 12 of the target user U_{C} approval or refusal of the companion request from the user U_{A}. Upon receiving the approval of the companion request from the terminal device 12 of the target user U_{C} (S53), the control device 32 adds the identification information P_{ID} of the target user U_{C} to the companion information F of the user U_{A} and adds the identification information P_{ID} of the user U_{A} to the companion information F of the target user U_{C} (S54). A companion relationship is established between the user U_{A} and the target user U_{C}. Subsequently, the control device 32 determines whether the target user U_{C} is one of the constituent members U_{B} of the current preliminary user set for the user U_{A} (whether the identification information P_{ID} of the target user U_{C} is included in the preliminary user set information Q of the user U_{A}) (S55).

When the target user U_{C} is not one of the constituent members U_{B} of the preliminary user set for the user U_{A} (S55: NO), the control device 32 sets the degree of intimacy f between the user U_{A} and the target user U_{C} to an initial value f₀ (S56). The initial value f₀ is, for example, zero. On the other hand, when the target user U_{C} is one of the constituent members U_{B} of the preliminary user set for the user U_{A} (S55: YES), the control device 32 sets the degree of intimacy f between the user U_{A} and the target user U_{C} to a predetermined value f₁ that is greater than the initial value f₀ (S57). The predetermined value f₁ is, for example, the maximum value of the degree of intimacy f. For the target user U_{C} differing from the constituent members U_{B}, the degree of intimacy f needs to be increased from the initial value f₀ through interaction on and after the establishment of the companion relationships, whereas for the constituent members U_{B} of the preliminary user set, the degree of intimacy f is set to a predetermined value (the maximum value) f₁ immediately when the companion relationship is established.

As is understood from the foregoing description, the control device 32 executes the process from Step S55 to Step S57, whereby an element (benefit awarder) for granting benefit of a greater degree (benefit of setting the degree of intimacy f to the predetermined value f₁ from the beginning) in a case in which a companion relationship is established in response to a companion request from the user U_{A} to the constituent member U_{B} of the preliminary user set for the user U_{A}, in comparison with the benefit granted in a case in which a companion relationship is established in response to a companion request from the user U_{A} to a user who is not a constituent member U_{B} of the preliminary user set for the user U_{A}. In a case in which the target user U_{C} refuses the companion request from the user U_{A}, the companion information F on the user U_{A} and on the target user U_{C} are not updated.

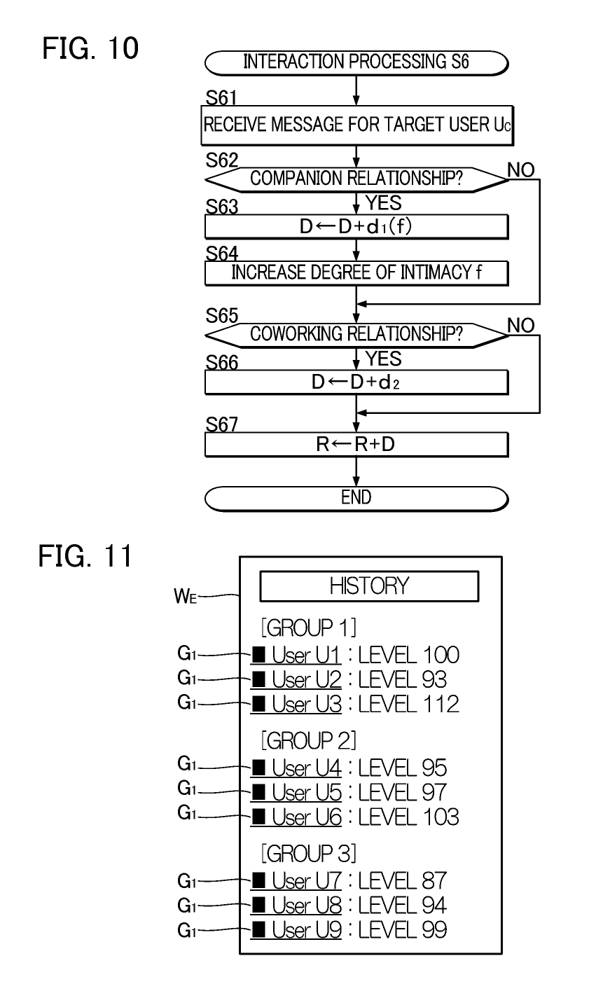

When the user U_{A} operates the operation image W_{E3} of FIG. 8, the control device 32 executes an interaction processing S6, of FIG. 10, for the user U_{A} to interact (exchange messages) with the target user U_{C}. The user U_{A} appropriately operates the input device 28, thereby operating the operation image W_{E3} and specifying a message for the target user U_{C}. The control device 32 receives, from the terminal device 12 of the user U_{A}, an interaction instruction with regard to the target user U_{C} (operation to the operation image W_{E3}) and a message to the target user U_{C} (S61). A message from the user U_{A} is notified to the terminal device 12 of the target user U_{C} with an operation to the terminal device 12 of the target user U_{C} as a trigger.

Upon receiving the interaction instruction and the message for the target user U_{C} from the terminal device 12 of the user U_{A} (S61), the control device 32 executes the following processes for the point holdings R of the user U_{A} and of the target user U_{C} to increase by an addition amount D (S62 to S66). The addition amount D is set to a predetermined initial value at the start of a process described below.

The control device 32 determines whether a companion relationship has been established between the user U_{A} and the target user U_{C} (whether each piece of the companion information F for the user U_{A} and the target user U_{C} each includes the identification information P_{ID} of the other) (S62). When the user U_{A} and the target user U_{C} are in a companion relationship (S62: YES), the control device 32 adds a specially added value d₁(f) to the addition amount D (S63). The specially added value d₁(f) is a benefit for the companion relationship between the user U_{A} and the target user U_{C}, and is set variably according to the degree of intimacy f between the user U_{A} and the target user U_{C}.

Specifically, the specially added value d₁(f) increases as the degree of intimacy f is greater. Subsequently, the control device 32 increases the degree of intimacy f between the user U_{A} and the target user U_{C} (S64). For example, a predetermined value is added to the degree of intimacy f. Thus, users who are in the companion relationship interact with each other, whereby the degree of intimacy f between the users increases, and the addition amount D to be added to the point holdings R at the time of interaction increases. On the other hand, when the user U_{A} and the target user U_{C} are not in a companion relationship (S62: NO), the process of adding the specially added value d₁(f) to the addition amount D (S63) and the process of increasing the degree of intimacy f (S64) are not executed.

The control device 32 determines whether the target user U_{C} is one of the constituent members U_{B} of the preliminary user set for the user U_{A} (whether the preliminary user set information Q for the user U_{A} includes the identification information P_{ID} of the target user U_{C}) (S65). In a case in which the target user U_{C} is in a coworking relationship with the user U_{A} (S65: YES), the control device 32 adds a specially added value d₂ to the addition amount D (S66). The specially added value d₂ is a benefit for the coworking relationship between the user U_{A} and the target user U_{C}, and is set to a fixed value or to a variable value. On the other hand, in a case in which the user U_{A} and the target user U_{C} are not in a coworking relationship (S65: NO), the process of adding the specially added value d₂ to the addition amount D (S66) is not executed. In a case in which the user U_{A} and the target user U_{C} are in the companion relationship and also in the coworking relationship (in a case in which the target user U_{C} is one of the companion constituent members U_{B1} of the user U_{A}), both the adding process of the specially added value d₁(f) in Step S63 and the adding process of the specially added value d₂ in Step S66 are executed.

The control device 32 adds the addition amount D set in the above processing for each of the user U_{A} and the target user U_{C} to the point holdings R of the respective users (S67). As has been described above, when the user U_{A} and the target user U_{C} are in a companion relationship, the specially added value d₁(f) according to the degree of intimacy f between the two users is added to the point holdings R of the two users, and when the target user U_{C} is in the coworking relationship with the user U_{A}, the specially added value d₂ is added to the point holdings R of the two users. Thus, the control device 32 executes the process from Step S62 to Step S67, whereby an element (manager) for managing the point holdings R for respective users is actualized, and when users who are in the companion relationship interact in a game, the point holdings R of each user is increased according to the degree of intimacy f between them. In the above example, the addition amount D is added to the point holdings R for both of the user U_{A} and the target user U_{C}, but the addition amount D may be added to the point holdings R of only the user U_{A}. As described in the foregoing, in the first embodiment, respective constituent members U_{B} of the preliminary user set who participate in a coworking event together with the user U_{A} are suggested to the user U_{A} in the preliminary user set image W_{B1}, and a companion request to one of the constituent members U_{B} suggested in the preliminary user set image W_{B1} is instructed by the user U_{A}. Since the constituent members U_{B} of the preliminary user set participate in the coworking event together with the user U_{A}, the user U_{A} is more likely to feel the feeling of closeness towards them in comparison with users who are not constituent members U_{B}. Thus, an experience for the user U_{A} of coworking with each constituent member U_{B} in coworking events can act as a trigger for building companion relationships with the constituent member U_{B}. Therefore, according to the first embodiment, in comparison with a configuration in which, for example, target users U_{C} in the candidate-for-request image W_{D} only become candidates for a companion request, there is an advantage in that the companion relationship between users is more likely to be promoted. In the first embodiment, especially, the preliminary user set is dissolved after the execution of the coworking event multiple times. Since this dissolution of the preliminary user set acts as a trigger for building companion relationships with the constituent members U_{B}, the effect that the establishment of the companion relationship between users is promoted is especially remarkable.

In the first embodiment, when the companion relationship is established between the user U_{A} and the constituent member U_{B} of the preliminary user set, a greater benefit is granted in comparison with a case in which the companion relationship is established between the user U_{A} and a user who is not the constituent member U_{B} (i.e., the degree of intimacy f is set to the maximum value at the time when the companion relationship is set). Thus, since motivation for building a companion relationship with the constituent member U_{B} of the preliminary user set is provided to each user, it is advantageous that the establishment of the companion relationship between users can be effectively promoted.

In the first embodiment, the number of persons K₁ of the companion constituent members U_{B1} and the number of persons K₂ of the non-companion constituent members U_{B2} (proportion between them) are set so as to vary depending on the current number of companions N for the user U_{A} (and additionally according to the upper limit number of companions Nₘₐₓ). Specifically, when the current number of companions N has not reached the upper limit number of companions Nₘₐₓ, the constituent members U_{B} of the preliminary user set are selected so as to include non-companion constituent members U_{B2}. Also, the constituent members U_{B} of the preliminary user set are selected so that the fewer the current number of companions N for the user U_{A} is, the greater the number of persons K₂ of the non-companion constituent members U_{B2} will increase. Therefore, it is possible to promote the establishment of companion relationships effectively, especially for the user U_{A} for whom the current number of companions N is small. On the other hand, when the current number of companions N has reached the upper limit of the number of companions Nₘₐₓ, every constituent member U_{B} of the preliminary user set is the companion constituent member U_{B1}. Therefore, there is an advantage in that a situation is avoided in which a constituent member U_{B}, who has not established the companion relationship, is suggested to the user U_{A} who has no capacity to newly establish a companion relationship.

### Second Embodiment

In the following, the second embodiment of the present invention will be described.

In each of the embodiments illustrated in the following, description is omitted as appropriate of those elements for which the actions and functions are the same as in the first embodiment, by applying the same reference numbers assigned in the above description.

In the first embodiment, an example was given of the preliminary user set information Q specifying the constituent members U_{B} of one preliminary user set that is currently effective. The preliminary user set information Q of the second embodiment specifies each piece of the identification information P_{ID} of each constituent member U_{B} for both the one preliminary user set that is currently effective and each preliminary user set that was established in the past and has been dissolved. The preliminary user set information Q also specifies the number of times of participation M with respect to the one preliminary user set that is currently effective.

When the user U_{A} assigns a predetermined operation to the input device 28 of the terminal device 12, the control device 32 causes the display device 26 of the terminal device 12 of the user U_{A} to display a history image W_{F} of FIG. 11 by referring to the preliminary user set information Q. The history image W_{F} is an image suggesting constituent members U_{B} of respective preliminary user sets established in the past for the user U_{A}. Specifically, for each of the currently effective preliminary user set and preliminary user sets that were established in the past but have been dissolved, the user name G₁ and a level for each constituent member U_{B} are displayed. Similarly to the first embodiment, each user name G₁ is linked to the individual page W_{E} of each constituent member U_{B}. Therefore, the control device 32 can receive a companion request from the user U_{A} to one of the constituent members U_{B} suggested in the preliminary user set image W_{B1} of the game screen W_{B} or of the game screen W_{C} or in the history image W_{F} of FIG. 11. In a case in which the companion relationship is established with one of the constituent members U_{B} of the past preliminary user sets, a greater benefit is granted to the user U_{A} in comparison with a case in which the companion relationship is established with one of the candidates in the candidate-for-request image W_{D}.

In the second embodiment, the same effects as in the first embodiment can be attained. Also, in the second embodiment, the constituent members U_{B} of not only the currently effective preliminary user set, but also of preliminary user sets dissolved in the past, are suggested to the user U_{A} as objects for a companion request. Therefore, in comparison with the first embodiment in which only constituent members U_{B} of the currently effective preliminary user set are suggested to the user U_{A}, the effect that the establishment of the companion relationship between users is promoted is especially remarkable.

### Third Embodiment

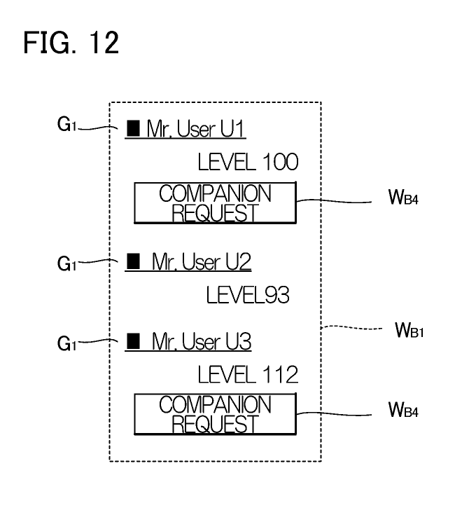

FIG. 12 is a schematic diagram of the preliminary user set image W_{B1} arranged in the game screen W_{B} (FIG. 5) or the game screen W_{C} (FIG. 6) in the third embodiment. In the same way as in the first embodiment, each constituent member U_{B} of the preliminary user set for the user U_{A} is suggested in the preliminary user set image W_{B1}. As described in the first embodiment, the preliminary user set can include the companion constituent members U_{B1} who have established companion relationships with the user U_{A} and the non-companion constituent members U_{B2} who have not yet established companion relationships with the user U_{A}. The control device 32 determines, for each constituent member U_{B} of the preliminary user set, whether there is a companion relationship with the user U_{A}, displays the operation image W_{B4} for the non-companion constituent members U_{B2}, and omits the display of the operation image W_{B4} for the companion constituent members U_{B1}. In FIG. 12, an example is shown in which a user for whom the user name G₁ is “User U₁” and a user for whom the user name G₁ is “User U₃” are the non-companion constituent members U_{B2} and in which a user for whom the user name G₁ is “User U₂” is the companion constituent member U_{B1}.

The operation image W_{B4} is an image (a link object) for a user to instruct a companion request to the constituent members U_{B} (non-companion constituent members U_{B2}). The user U_{A} operates the operation image W_{B4} of one of the non-companion constituent members U_{B2} with whom the user U_{A} wishes to establish a companion relationship. In Step S51 of FIG. 9, the control device 32 receives an operation to the operation image W_{B4} from the user U_{A} as an instruction for a companion request for the constituent members U_{B} (non-companion constituent members U_{B2}) corresponding to the operation image W_{B4}. The operation thereafter is the same as in the first embodiment.

In the third embodiment, the same effects as in the first embodiment can be attained. In the first embodiment, in order to instruct a companion request to the non-companion constituent members U_{B2}, it is necessary to move to the individual page W_{E} (FIG. 8) of the user. In the third embodiment, the operation image W_{B4} arranged in the preliminary user set image W_{B1} is operated. Thus, the user U_{A} can instruct a companion request to one of the non-companion constituent members U_{B2} without having to move to the individual page W_{E}. Therefore, the procedure necessary for a companion request is simplified, and it is possible to attain an effect that the establishment of the companion relationship can be consequently promoted.

### Modifications

The above embodiments can be modified in various ways. Specific examples of modifications will be illustrated in the following. Two or more of the following modification examples can be freely selected and combined as long as they do not conflict with each other.

(1) In each of the embodiments described above, an example was given of a case in which a game is provided to each terminal device 12 as a browser-type application. Alternatively, one or more of the functions of the game device 14 of each of the embodiments described above can be actualized by the control device 20 executing a native-type application stored in the storage device 22 of each terminal device 12. As is understood from the foregoing description, the game device 14 of the present invention is a concept that includes the terminal device 12 that executes a native-type application in addition to the game device 14 of each of the embodiments described above.

(2) A method for selecting K constituent members U_{B} constituting the preliminary user set is not limited to the above examples. For example, in each of the embodiments described above, an example was shown in which the preliminary user set can include both the companion constituent members U_{B1} and the non-companion constituent members U_{B2}. However, from the viewpoint of promoting the establishment of a new companion relationship, a configuration of constituting the preliminary user set with the non-companion constituent members U_{B2} only, who have not established companion relationships with the user U_{A}, is also preferable. As is understood from the foregoing description, a preliminary user set that is preferable from a viewpoint of promoting the establishment of a new companion relationship can be understood as a group including users (non-companion constituent members U_{B2}) who have not established companion relationships with the user U_{A}.

Also, since the companion relationship illustrated in each of the embodiments described above is a mutualistic relationship between users, it is desirable if there is capacity for not only the user U_{A} but also for the non-companion constituent members U_{B2} to increase companions from a viewpoint of promoting the establishment of a new companion relationship. Therefore, in addition to or alternatively to the conditions illustrated in each of the above configurations, a configuration of selecting only a user for whom the current number of companions N has not reached the upper limit number of companions Nₘₐₓ (a user who has capacity to increase the number of companions) as the non-companion constituent members U_{B2} of the preliminary user set for the user U_{A} is also preferable.

(3) In each of the embodiments described above, the preliminary user set is dissolved when the number of times of participation M in a coworking event reaches the predetermined value M_{TH}, but a condition for dissolving the preliminary user set can be modified as appropriate. For example, the preliminary user set can be dissolved when a predetermined time has passed since the preliminary user set was established. However, if the passage of time is used as the mere condition for dissolution of the preliminary user set, there is a possibility that a preliminary user set will be dissolved without participating in a coworking event, not even once. Therefore, as in each of the embodiments described above, a configuration to dissolve the preliminary user set after participating in coworking events multiple times is preferable. Also, it is also possible to dissolve the preliminary user set when a specific condition relating to the game is satisfied (e.g., when a specific event is executed).

(4) In each of the embodiments described above, the user U_{A} and each constituent member U_{B} of the preliminary user set fight against the common opponent character in a coworking event, but the content of the coworking event is not limited to the above examples. For example, an event in which the user U_{A} and each constituent member U_{B} of the preliminary user set fight with one another can be executed as a coworking event.

(5) In each of the embodiments described above, the degree of intimacy f is set to the predetermined value f₁ and is awarded as a benefit, but the content of benefit awarded when the companion relationship is formed with the constituent members U_{B} of the preliminary user set can be freely selected. For example, when the companion relationship is established with the constituent members U_{B}, a greater number of points can be granted to each user in comparison with a case in which the companion relationship is established with a user who is not one of the constituent members U_{B}.

(6) In each of the embodiments described above, an item is granted to the user U_{A} in exchange for consumption of the point holdings R of the predetermined amount (lottery event), but the use of the point holdings R is not limited to the above examples. For example, a configuration of combining or strengthening items of the user U_{A} in exchange for consumption of the point holdings R of the predetermined amount or a configuration in which the user U_{A} participates in a specific event in exchange for consumption of the point holdings R of the predetermined amount may be employed.

(7) In each of the embodiments described above, the preliminary user sets are defined for respective users. Accordingly, a configuration is preferable in which the control device 32 ranks preliminary user sets for different users and to cause the display device 26 of each terminal device 14 to display the ranking. The ranking of the preliminary user sets are determined, for example, based on the total of the ability values of respective constituent members U_{B} or depending on the number of victories, etc., in coworking events. It is also possible to rank plural constituent members U_{B} constituting the preliminary user set for the user U_{A}, to display the ranking on the display device 26 of the terminal device 14 of the user U_{A}. The raking among constituent members U_{B} is determined, for example, depending on the degree of contribution (e.g., the total damage made to an opponent character) in coworking events.

(8) The preliminary user set may be dissolved at a freely selected timing after execution of an event (coworking event). For example, in each of the embodiments described above, the preliminary user set is dissolved immediately after the execution of the coworking event (Step S38 of FIG. 4), it is possible to dissolve the preliminary user set when a predetermined condition (e.g., execution of a specific event) is satisfied after execution of a coworking event.

(9) In each of the embodiments described above, the entire preliminary user set is dissolved, but it is possible for only a part of the preliminary user set to be dissolved. That is, only one or more of plural constituent members U_{B} of the preliminary user set for the user U_{A} may leave the preliminary user set, and the other constituent members U_{B} continue to remain with the preliminary user set for the user U_{A}. Then, new constituent members U_{B} are added to the remaining constituent members U_{B}, whereby a new preliminary user set is defined for the user U_{A}. This can be said in another way that constituent members U_{B} from past preliminary user sets (already dissolved) may participate in the newly defined preliminary user set for the user U_{A}. As is understood from the foregoing description, the dissolution of the preliminary user set includes the dissolution of a part of a preliminary user set in addition to the dissolution of the entire preliminary user set.

The following aspects of the invention are understood from the embodiments and modifications described in the foregoing.

In one aspect, a game device of the present invention is a game device for providing users with a game in which a companion relationship between the users is established, the game device having: an event processor configured to execute an event in which a first user and a preliminary user set (preliminary user group) including at least one second user participate, the at least one second user including a user who has not established a companion relationship with the first user; a display controller configured to cause a display device to display a preliminary user set image suggesting, to the first user, the at least one second user included in the preliminary user set; and a request receiver configured to receive, from the first user, an instruction for a companion request to one of the at least one second user suggested in the preliminary user set image. The at least one second user suggested in the preliminary user set image is one or more or all of the at least one second user included in the preliminary user set of the first user.

In a non-limiting embodiment of the game device according to the present invention, the game device 14 has the control device (circuitry) 32 configured to: execute a coworking event in which the user U_{A} and a preliminary user set including at least one constituent user U_{B} participate, the at least one constituent member U_{B} including a non-companion constituent member U_{B2} who has not established a companion relationship with the user U_{A} (Step S34 of FIG. 4); cause the display device 26 of the terminal device 12 to display a preliminary user set image W_{B1} suggesting, to the user U_{A}, at least one constituent member U_{B} included in the preliminary user set (Step S33 or Step S37); and receive, from the user U_{A}, an instruction for a companion request to one of the at least one constituent member U_{B} suggested in the preliminary user set image W_{B1} (Step S51 of FIG. 9).

The game device according to a preferred embodiment of the present invention additionally has a user set dissolver configured to dissolve the preliminary user set after execution of an event in which the preliminary user set participates. For example, the user set dissolver is configured to dissolve the preliminary user set when the number of times of execution of an event in which the preliminary user set participate has reached a predetermined number of times, or when a specific condition (e.g., a specific event is executed), relating to a game, is satisfied.

In a non-limiting embodiment of the present invention, the control device 32 is configured to dissolve the preliminary user set for the user U_{A} after a multiple number of times (M_{TH} number of times) of execution of coworking events in which the preliminary user set for the user U_{A} participates (Step S36 and Step S38 of FIG. 4).

The game device according to a preferred embodiment of the present invention additionally has a user set definer configured to select, from among plural users, the at least one second user included in the preliminary user set for the first user, and the user set definer is configured to change, depending on the number of users who have established companion relationships with the first user, the total number of second users who have not established companion relationships with the first user and the total number of second users who have established companion relationships with the first user out of the at least one second user. For example, the fewer the number of users who are in companion relationships with the first user, the more the user set definer increases the total number of second users who have not established companion relationships.

In a non-limiting embodiment of the present invention, the control device 32 is configured to select, out of plural users, at least one constituent member U_{B} included in the preliminary user set for the user U_{A} (Step S32 of FIG. 4). In Step S32, the control device 32 changes the number of members K₁ of the companion constituent members U_{B1} and the number of members K₂ of the non-companion constituent members U_{B2} (prop ortion of K₁ and K₂).

According to a preferred embodiment of the present invention, the user set definer is configured to select the at least one second user so as to include a user who has not established a companion relationship with the first user in a case in which the number of users who have established companion relationships with the first user has not reached an upper limit value of the number of users with whom the first user is allowed to establish companion relationships, and is configured to select a user who has established a companion relationship with the first user as the at least one second user in a case in which the number of users who have established companion relationships with the first user has reached the upper limit value.

In a non-limiting embodiment of the present invention, when the current number of companions N of the user U_{A} has not reached the upper limit number of companions Nₘₐₓ, the control device 32 is configured to select the K constituent members U_{B} so as to include at least one non-companion constituent member U_{B2}. On the other hand, when the current number of companions N of the user U_{A} has reached the upper limit number of companions Nₘₐₓ, the control device 32 is configured to select the K constituent members U_{B} so that every member of the K constituent members U_{B} will be the companion constituent member U_{B1}.

According to a preferred embodiment of the present invention, a definition (or establishment) and a dissolution of the preliminary user set for the first user are sequentially repeated, the display controller is configured to cause the display device of the first user to display a history image suggesting, to the first user, each second user of each preliminary user set defined for the first user in the past, and the request receiver is configured to receive, from the first user, an instruction for a companion request to one of the at least one second user suggested in the preliminary user set image or in the history image. Combinations of the second user of each preliminary user set defined sequentially for the first user may be different. That is, a configuration in which a combination of second users vary for each preliminary user set or a configuration in which second users can overlap among different preliminary user sets is employed.

In a non-limiting embodiment of the present invention, a definition and dissolution of the preliminary user set for the user U_{A} are sequentially repeated by the control device 32. The controller device 32 is configured to cause the display device 26 of the terminal device 12 of the user U_{A} to display a history image W_{F} (FIG. 11) suggesting constituent members U_{B} of respective preliminary user sets established in the past for the user U_{A} and receive from the user U_{A}, an instruction for a companion request to one of the at least one constituent members U_{B} suggested in the preliminary user set image W_{B1} or in the history image W_{F}.

A game device according to a preferred embodiment of the present invention additionally has a benefit awarder configured to award a benefit to the first user when a companion relationship is established in response to a companion request from the first user to one of the at least second users included in the preliminary user set, and the awarded benefit is greater in comparison with a case in which a companion relationship is established in response to a companion request from the first user to a user other than the at least one second user. For example, in a configuration having a manager configured to manage points usable by each user in a game for the corresponding user, and when respective users who have established a companion relationship mutually interact in a game, increase the points of the corresponding users as many points as which correspond to a degree of intimacy set for the companion relationship between the users, the benefit awarder is configured to set the degree of intimacy of users between whom a companion relationship is established in response to a companion request from the first user to one of the at least second user included in the preliminary user set, to a greater numerical value in comparison with a numerical value set to the degree of intimacy of users between whom a companion relationship is established in response to a companion request from the first user to a user other than the at least one second user.

In a non-limiting embodiment of the present invention, the control device 32 is configured to grant benefit of setting the degree of intimacy f to the predetermined value f₁ (the maximum value) from the beginning in a case in which a companion relationship is established in response to a companion request from the user U_{A} to the constituent member U_{B} of the preliminary user set for the user U_{A}, in comparison with the benefit granted in a case in which a companion relationship is established in response to a companion request from the user U_{A} to a user who is not the constituent member U_{B} of the preliminary user set for the user U_{A}.

According to a preferred embodiment of the present invention, the display controller is configured to arrange, inside the preliminary user set image, an operation image for a companion request to a second user from among plural second users included in the preliminary user set, the second user not having established a companion relationship with the first user, and the request receiver is configured to receive an operation made to the operation image as an instruction for a companion request to the second user.

In a non-limiting embodiment of the present invention, the control device 32 is configured to arrange, inside the preliminary user set image W_{B1}, the operation image W_{B4} (FIG. 12) for the non-companion constituent members U_{B2}, and receive an operation made to the operation image W_{B4} as an instruction for a companion request to the constituent member U_{B}.

The present invention can be envisaged as a program for causing a computer to serve as a game device according to each of the above embodiments. The program of the present invention is a program for providing users with a game in which a companion relationship between the users is established, the program causing a computer to execute: an event process of executing an event in which a first user and a preliminary user set including at least one second user participate, the at least one second user including a user who has not established a companion relationship with the first user; a display control process of causing a display device to display a preliminary user set image suggesting, to the first user, the at least one second user included in the preliminary user set; and a request receiving process of receiving, from the first user, an instruction for a companion request to one of the at least one second user suggested in the preliminary user set image.

The program of the present invention is provided in a manner stored in a computer-readable recording medium and is installed in a computer. The recording medium is, for example, a non-transitory recording medium, one good example of which is an optical recording medium (optical disc) such as a CD-ROM, and can include a freely selected form of publically known recording mediums such as a semi-conductor recording medium or a magnetic recording medium. Moreover, for example, the program of the present invention can be provided in a form of distribution over a communication network and be installed in a computer. A recording medium that can be accessed by a distribution server that distributes the program of the present invention (e.g., a storage device inside or outside a distribution server) is included in the concept of the above recording medium.

The present invention can be envisaged as a method for managing a game in which a companion relationship between users is established (an operation method of the game device of the present invention). A game management method according the present invention executes an event in which a first user and a preliminary user set including at least one second user participate, the at least one second user including a user who has not established a companion relationship with the first user; causes a display device to display a preliminary user set image suggesting, to the first user, the at least one second user included in the preliminary user set; and receives, from the first user, an instruction for a companion request to one of the at least one second user suggested in the preliminary user set image.

### DESCRIPTION OF REFERENCE NUMERALS

100 . . . game system, 12 . . . terminal device, 14 . . . game device, 16 . . . communication network, 20,32 . . . control device, 22,34 . . . storage device, 24,36 . . . communication device, 26 . . . display device, 28 . . . input device.

What is claimed is:

1. A game device for providing users with a game in which a companion relationship between the users is established, the game device comprising:
an event processor configured to execute an event in which a first user and a preliminary user set including at least one second user participate, the at least one second user including a user who has not established a companion relationship with the first user;
a display controller configured to cause a display device to display a preliminary user set image suggesting, to the first user, the at least one second user included in the preliminary user set; and
a request receiver configured to receive, from the first user, an instruction for a companion request to one of the at least one second user suggested in the preliminary user set image.

2. The game device of claim 1, further comprising a user set dissolver configured to dissolve the preliminary user set after execution of an event in which the preliminary user set participates.

3. The game device of claim 2, wherein the user set dissolver is configured to dissolve the preliminary user set when the number of times of execution of an event in which the preliminary user set participates has reached a predetermined number of times.

4. The game device of claim 1, further comprising a user set definer configured to select, from among plural users, the at least one second user included in the preliminary user set for the first user,
wherein the user set definer is configured to change, depending on a number of users who have established companion relationships with the first user, a total number of second users who have not established companion relationships with the first user and a total number of second users who have established companion relationships with the first user out of the at least one second user.

5. The game device of claim 4, wherein the user set definer is configured to select the at least one second user so as to include a user who has not established a companion relationship with the first user in a case in which the number of users who have established companion relationships with the first user has not reached an upper limit value of the number of users with whom the first user is allowed to establish companion relationships, and is configured to select a user who has established a companion relationship with the first user as the at least one second user in a case in which the number of users who have established companion relationships with the first user has reached the upper limit value.

6. The game device of claim 1,
wherein a definition and a dissolution of the preliminary user set for the first user are sequentially repeated,
wherein the display controller is configured to cause the display device of the first user to display a history image suggesting, to the first user, each second user of each preliminary user set defined for the first user in the past, and
wherein the request receiver is configured to receive, from the first user, an instruction for a companion request to one of the at least one second user suggested in the preliminary user set image or in the history image.

7. The game device of claim 1, further comprising a benefit awarder configured to award a benefit to the first user when a companion relationship is established in response to a companion request from the first user to one of the at least second users included in the preliminary user set, the awarded benefit being greater in comparison with a case in which a companion relationship is established in response to a companion request from the first user to a user other than the at least one second user.

8. The game device of claim 7, further comprising a manager configured to manage points usable by each user in a game for the corresponding user, and when respective users who have established a companion relationship mutually interact in a game, increase the points of the corresponding users as many points as which correspond to a degree of intimacy set for the companion relationship between the users,
wherein the benefit awarder is configured to set the degree of intimacy of users between whom a companion relationship is established in response to a companion request from the first user to one of the at least second user included in the preliminary user set, to a greater numerical value in comparison with a numerical value set to the degree of intimacy of users between whom a companion relationship is established in response to a companion request from the first user to a user other than the at least one second user.

9. The game device of claim 1,
wherein the display controller is configured to arrange, inside the preliminary user set image, an operation image for a companion request to a second user from among plural second users included in the preliminary user set, the second user not having established a companion relationship with the first user, and
wherein the request receiver is configured to receive an operation made to the operation image as an instruction for a companion request to the second user.

10. A non-transitory computer-readable recording medium having stored a program for providing users with a game in which a companion relationship between the users is established, the program causing a computer to execute:
an event process of executing an event in which a first user and a preliminary user set including at least one second user participate, the at least one second user including a user who has not established a companion relationship with the first user;
a display control process of causing a display device to display a preliminary user set image suggesting, to the first user, the at least one second user included in the preliminary user set; and
a request receiving process of receiving, from the first user, an instruction for a companion request to one of the at least one second user suggested in the preliminary user set image.

11. A method for managing a game in which a companion relationship between users is established, the method comprising:
executing an event in which a first user and a preliminary user set including at least one second user participate, the at least one second user including a user who has not established a companion relationship with the first user;
causing a display device to display a preliminary user set image suggesting, to the first user, the at least one second user included in the preliminary user set; and
receiving, from the first user, an instruction for a companion request to one of the at least one second user suggested in the preliminary user set image.
